(19) United States
(12) Patent Application Publication
(10) Pub. No.: US 2020/0298226 A1
(43) Pub. Date: Sep. 24, 2020

(54) FLUID EJECTION DIES WITH FLUID CLEANING STRUCTURES

(71) Applicant: HEWLETT-PACKARD DEVELOPMENT COMPANY, L.P., Spring, TX (US)

(72) Inventors: Kathryn Cyr, Corvallis, OR (US); Debora J. Thomas, Corvallis, OR (US); Jeffrey A. Nielsen, Corvallis, OR (US)

(73) Assignee: HEWLETT-PACKARD DEVELOPMENT COMPANY, L.P., Spring, TX (US)

(21) Appl. No.: 16/765,705

(22) PCT Filed: Dec. 15, 2017
(86) PCT No.: PCT/US2017/066600

§ 371 Date: May 20, 2020

(51) Int. Cl. B01L 3/02

(52) U.S. Cl. CPC B01L 3/0268; B01L 13/00; B01L 2300/0627; B01L 2200/0642; B01L 2300/12; B01L 2200/141; B01L 2200/0652

(57) ABSTRACT

In one example in accordance with the present disclosure, a fluid ejection die is described. The fluid ejection die includes a fluid feed slot to deliver fluid from a reservoir to an array of nozzles. Each nozzle of the array includes an ejection chamber, an opening, a fluid actuator disposed within the ejection chamber, and a fluid channel between the fluid feed slot and the ejection chamber. The fluid ejection die also includes a fluid cleaning structure to allow live cells in the fluid to pass to the nozzle while capturing other components.

### BACKGROUND

A fluid ejection die is a component of a fluid ejection system that ejects fluid from a reservoir onto a surface, To eject the fluid, the fluid ejection die includes a number of components. Specifically, the fluid to be ejected is held in an ejection chamber. A fluid actuator operates to dispel the fluid in the ejection chamber through an opening. As the fluid is expelled, a negative pressure within the ejection chamber draws additional fluid into the ejection chamber, and the process repeats.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluid ejection die with a fluid cleaning structure, according to an example of the principles described herein.

FIG. 2A is a top view of a fluid ejection system including a fluid ejection device with a fluid ejection die with a fluid cleaning structure, according to an example of the principles described herein.

FIG. 2B is a bottom view of a fluid ejection system including a fluid ejection device with a fluid ejection die with a fluid cleaning structure, according to an example of the principles described herein.

FIG. 3 is a top view of a fluid ejection system including a fluid ejection device with a fluid ejection die with a fluid cleaning structure, according to an example of the principles described herein.

FIG. 4 is a view of a fluid ejection device with a fluid ejection die with a fluid cleaning structure, according to an example of the principles described herein.

FIG. 5 is a side cross-sectional view of a nozzle of a fluid ejection die with a fluid cleaning structure, according to an example of the principles described herein.

FIG. 6 is a top cross-sectional view of a portion of a fluid ejection die with a fluid cleaning structure, according to an example of the principles described herein.

FIG. 7 is a top cross-sectional view of a portion of a fluid ejection die with a fluid cleaning structure, according to an example of the principles described herein.

FIG. 8 is a top cross-sectional view of a portion of a fluid ejection die with a fluid cleaning structure, according to an example of the principles described herein,

FIG. 9 is a top cross-sectional view of a portion of a fluid ejection die with a fluid cleaning structure, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A fluid ejection die is a component of a fluid ejection system that ejects fluid from a reservoir onto a surface, To eject the fluid, the fluid ejection die includes a number of components. Specifically, the fluid to be ejected is held in an ejection chamber. A fluid actuator operates to dispel the fluid in the ejection chamber through an opening. As the fluid is expelled, a negative pressure within the ejection chamber draws additional fluid into the ejection chamber, and the process repeats. Such fluid ejection dies are used in many applications. In one example, the fluid ejection die may be used in a laboratory, as part of an assay of biological fluids.

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

While such assays undoubtedly are a valuable tool in all sorts of life science fields, advances to this area may increase the value they provide. For example, in general, these assays have been performed manually. That is, a user fills fluid into a single channel pipette, or a multi-channel pipette, and manually disperses a prescribed amount of fluid from the pipette into various wells of a titration plate. As this process is done by hand, it is tedious, complex, and inefficient. Moreover, it is prone to error as a user may misalign the pipette with the wells of the titration plate and/or may dispense an incorrect amount of fluid. Still further, such manual deposition of fluid may be incapable of dispensing low volumes of fluid, for example in the picoliter range.

Accordingly, the present specification describes a fluid ejection die that reduces a likelihood for human error, allows dispensing of low volume quantities of fluid, and is usable in various life science applications. Specifically, the present fluid ejection die allows for the dispensing dimethyl sulfoxide (DMSO)-based small molecule compounds and of biological fluids containing aqueous-based biomolecules such as proteins, lipids, and aligns. The fluid ejection die of the present specification also allows for the dispensing of cells. Such a cell-dispensing fluid ejection die enables a greater understanding of heterogeneous biological samples, cell isolation, and clone selection for biotechnology processes.

However, working with target fluids that include cells presents certain complications to be addressed. For example, ideally a sample of cells has a high degree of viable live cells and will be free of dead cells, burst cells, and other debris. However, dead cells and/or burst cells may be found in a target fluid. These dead cells and burst cells are sticky, and can clog the micro-fluidic channels, chambers, and nozzles in a fluid ejection die.

To address these complications, in some examples users have just assumed a reduced percentage of viable cells in a target fluid and analyzed the results accordingly. However, doing so is inefficient, wasteful, and could skew analysis results. In some cases, just new sample fluids with a higher percentage of viable cells are used. However, this may be ineffective as it reduces the body of target fluids on which cell dispensing can be performed as just those that are sufficiently new can be used. Still further, target fluids could be cleaned and prepared before dispensing, for example via centrifuge; however this does not remove all dead cells, burst cells, and debris and can be complex and time-consuming.

Accordingly, the fluid ejection die of the present specification includes a fluid cleaning structure that 1) allows live cells to pass and 2) captures the dead cells, burst cells, and other debris. Such a fluid cleaning structure 1) prevents the dead cells and burst cells from being dispensed, thus resulting in an improved target fluid for analysis, 2) prevents the dead cells, burst cells, and other debris from being incorrectly counted as cells in a closed-loop dispensing system, and 3) keeps the fluidic channels and chambers of the fluid ejection die free-flowing.

Specifically, the present specification describes a fluid ejection die. The fluid ejection die includes a fluid feed slot to deliver fluid from a reservoir to an array of nozzles. Each nozzle in the array includes an ejection chamber, an opening, a fluid actuator disposed within the ejection chamber, and a fluid channel between the fluid feed slot and the ejection chamber. The fluid ejection die also includes a fluid cleaning structure to allow live cells in the fluid to pass to the nozzle while capturing other components.

The present specification also describes a fluid ejection device. The fluid ejection device includes a reservoir to receive a quantity of fluid and a fluid ejection die. The fluid ejection die includes 1) a fluid feed slot to deliver fluid from the reservoir to an array of nozzles, 2) the array of nozzles, and a 3) fluid cleaning structure to allow live cells in the fluid to pass to the nozzle while capturing dead and burst cells.

The present specification also describes a fluid ejection system. The fluid ejection system includes a number of fluid ejection devices, each fluid ejection device including a reservoir to receive a quantity of fluid and a fluid ejection die. The fluid ejection system also includes a frame to retain the number of fluid ejection devices.

While specific reference is made to a fluid ejection die for use in life science applications, the fluid ejection die can be used in other applications, such as deposition of ink on a substrate, or depositing other types of fluid.

In summary, using such a fluid ejection die 1) enables ejection of cells onto a surface such as a titration plate; 2) allows dispensing of small quantities of a target fluid that includes the cells; 3) cleans dead cells, burst cells, and other debris from a target fluid resulting in a better target fluid with a higher ratio of live cells; 4) reduces cell counting errors by reducing the cell debris which improves the ability for a closed-loop system to accurately dispense the right amount of cells; 5) lengthens sensor, and fluid ejection device, life by preventing the contamination, blocking or damage to sensors via the cell debris; 6) prevents channel, chamber, and nozzle clogging; 7) enables improved understanding of heterogeneous biological samples; 8) facilitates efficient cell isolation; and 9) reduces the pre-dispensing operations as less cleaning and centrifuging is performed. However, the devices disclosed herein may address other matters and deficiencies in a number of technical areas.

As used in the present specification and in the appended claims, the term “a number of” or similar language is meant to be understood broadly as any positive number including 1 to infinity.

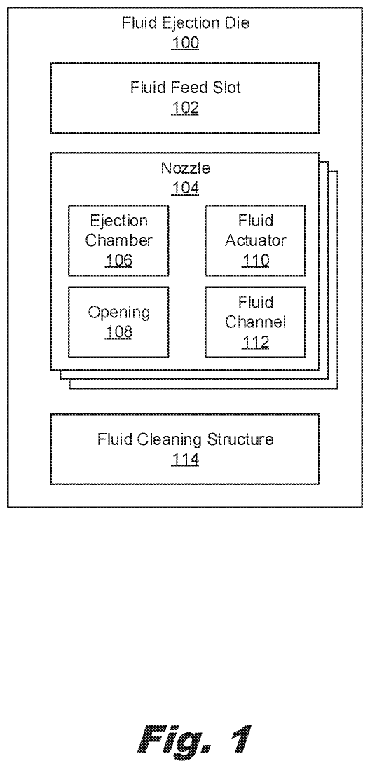

Turning now to the figures, FIG. 1 is a block diagram of a fluid ejection die (100) with fluid cleaning structure(s) (114), according to an example of the principles described herein. In general, a fluid ejection system ejects fluid onto a surface. As described above, the surface may be a titration plate with a number of wells, and the fluid may be deposited into the individual wells of the titration plate. A variety of fluids may be deposited. For example, the fluid ejection system may be implemented in a laboratory and may eject biological fluid. For example, the biological fluid may include live cells that are to be analyzed. Over the natural course of time, some of these live cells may burst, or otherwise die off. Accordingly, the biological fluid inevitably includes dead cells and burst cells. These dead cells and burst cells can be captured by the fluid cleaning structure (114) of the fluid ejection die (100). While specific reference is made to a biological fluid that includes live, dead, and burst cells, other biological fluids may be used as well. Examples of other biological fluids include solvent or aqueous-based pharmaceutical compounds, as well as aqueous-based biomolecules including proteins, enzymes, lipids, antibiotics, mastermix, primer, DNA samples, cells, or blood components, all with or without additives, such as surfactants or glycerol.

To eject the fluid, a fluid ejection controller passes control signals and routes them to fluid ejection dies (100) of the fluid ejection system. A fluid ejection die (100) refers to the component of a fluid ejection system that ejects the fluid. In some cases, the fluid ejection die (100) operates to dispense picoliter quantities of a target fluid into the wells. A fluid ejection die (100) may be paired with a reservoir to be referred to as a fluid ejection device.

The fluid ejection die (100) includes a number of components to eject fluid. First, each fluid ejection die (100) includes a fluid feed slot (102). The fluid feed slot delivers fluid from a reservoir of a fluid ejection device to the nozzles of the fluid ejection die (100). In some examples, the fluid feed slot (102) may deliver fluid to an array of nozzles (104).

Each fluid ejection die (100) also includes an array of nozzles (104) to eject a fluid. Each nozzle (104) includes a number of components. For example, a nozzle (104) includes an ejection chamber (106) to hold an amount of fluid to be ejected, an opening (108) through which the amount of fluid is ejected, and a fluid actuator (110), disposed within the ejection chamber (106), to eject the amount of fluid through the opening (108).

Turning to the fluid actuators (110), the fluid actuator (110) may include a firing resistor or other thermal device, a piezoelectric element, or other mechanism for ejecting fluid from the ejection chamber (106). For example, the fluid actuator (110) may be a firing resistor. The firing resistor heats up in response to an applied voltage. As the firing resistor heats up, a portion of the fluid in the ejection chamber (106) vaporizes to generate a bubble. This bubble pushes fluid out the opening (108) and onto the print medium. As the vaporized fluid bubble pops, fluid is drawn into the ejection chamber (106) from a passage that connects nozzle (104) to a fluid feed slot in the fluid ejection die (100), and the process repeats. In this example, the fluid ejection die (100) may be a thermal inkjet (TIJ) fluid ejection die (100).

In another example, the actuator (110) may be a piezoelectric device. As a voltage is applied, the piezoelectric device changes shape which generates a pressure pulse in the ejection chamber (106) that pushes the fluid out the opening (108) and onto the print medium. In this example, the fluid ejection die (100) may be a piezoelectric inkjet (PIJ) fluid ejection die (100).

Each nozzle (104) of the array also includes a fluid channel (112). The fluid channel receives fluid from the fluid feed slot (102) and passes it to the ejection chamber (106) of the nozzle (104).

The fluid ejection die (100) also includes a fluid cleaning structure (114). The fluid cleaning structure (114) allows live cells in the fluid to pass to the nozzle (104) while capturing other components. For example, over the course of time, live cells in a target fluid burst or otherwise die. Additionally, debris may contaminate the target fluid. Such dead cells, burst cells, and/or debris can affect the accuracy of fluid analysis results and can impact performance of the fluid ejection die (100). Accordingly, the fluid cleaning structure (114) separates the live cells from the dead cells, burst cells, and other debris to enhance analysis performance and improve fluid ejection die (100) life and performance.

The fluidic cleaning structure (114) may be a gold surface in the fluid path through the fluid ejection die (100). That is, the gold surface may be in the fluid feed slot (102), the fluid channel (112), or other locations within the nozzle (104). The dead cells and burst cells, on account of being sticky, are attracted to the gold surface and collected there. Accordingly, rather than depositing on sensors, or collecting within an ejection chamber (106) or opening (108), the dead cells, burst cells, and debris are collected in a targeted site. Such a gold surface may be formed by etching away a substrate layer within the fluid ejection die (100) that is disposed on top of a layer of gold material.

Such a fluid cleaning structure (114), by cleaning a fluid of dead cells, burst cells, or other debris, enhances the ratio of live, viable cells within a target fluid. Accordingly, cell counting operations that occur downstream of the fluid cleaning structure (114) do not mistakenly count dead cells and/or burst cells as live cells, thus enhancing the accuracy of such operations. Moreover, the fluid cleaning structure (114) prevents dead cells, burst cells, and/or other debris from clogging fluid ejection die (100) components such as ejection chambers (106), openings (108) or other sensors that may be found within the fluid ejection die (100). These effects, in addition to others, result in more accurate ejection, more accurate analysis of a corresponding fluid, and an increased life of components of the fluid ejection die (100) and therefore the fluid ejection die (100) as a whole.

Moreover, the fluid ejection die (100), by using inkjet components such as ejection chambers (106), openings (108), and fluid actuators (110) disposed within the micro-fluid ejection chambers (106), enables low-volume dispensing of fluids such as those used in life science and clinical applications. Examples of such applications include compound secondary screening, enzyme profiling, dose-response titrations, polymerase chain reaction (FOR) miniaturization, microarray printing, drug-drug combination testing, drug repurposing, drug metabolism and pharmacokinetics (DMPK) dispensing and a wide variety of other life science dispensing.

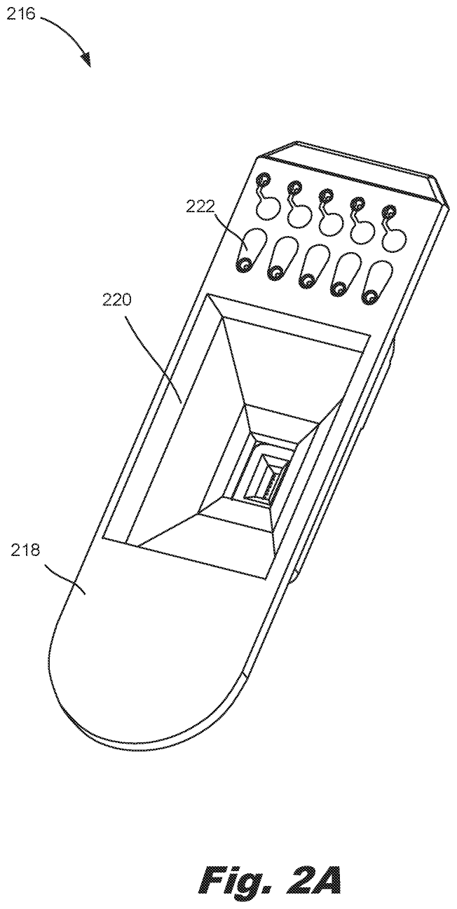

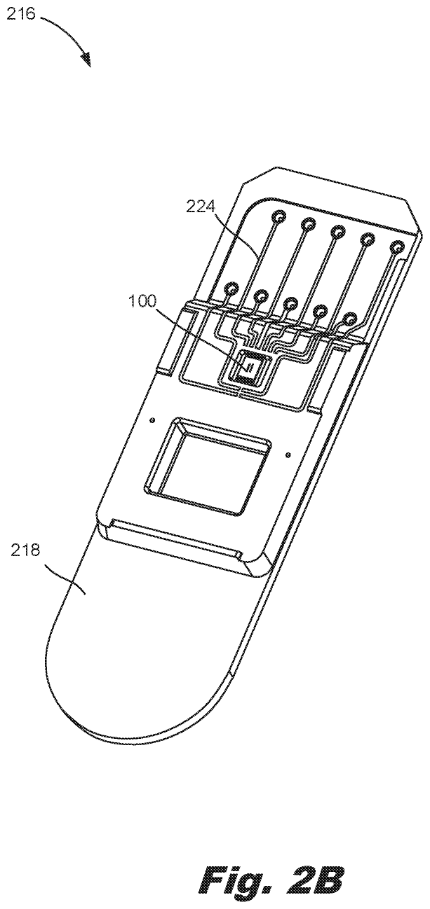

FIG. 2A is a top view of a fluid ejection system (216) including a fluid ejection device with a fluid ejection die (FIG. 1, 100) with a fluid cleaning structure (FIG. 1, 114), according to an example of the principles described herein. As used in the present specification, a fluid ejection device refers to a reservoir (220) and a fluid ejection die (FIG. 1, 100) and a fluid ejection system (216) refers to the fluid ejection device and a frame (218) that houses the fluid ejection device. That is, the fluid ejection system (216) includes a number of fluid ejection devices, with each fluid ejection device including 1) a reservoir (220) to receive a quantity of fluid and 2) a fluid ejection die (FIG. 1, 100) including a fluid feed slot (FIG. 1, 102), array of nozzles (FIG. 1, 104), and a fluid cleaning structure (FIG. 1, 114).

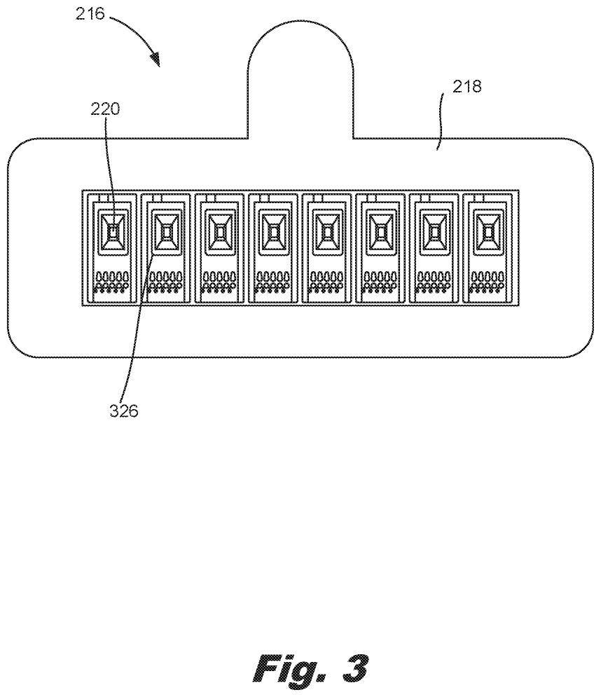

As described above, the fluid ejection system (216) includes a frame (218). The frame (218) may be of any material, such as a plastic. In one specific example, the frame (218) is an epoxy mold compound and is injection-molded. The fluid ejection devices may be disposed on the frame (102). In some examples, the reservoir (220) of the fluid ejection devices are integrated into the frame (218). That is, the frame (218) may be injection molded or otherwise manufactured out of a thermoplastic material. In this example, depressions correspond to the reservoirs (220) that hold the fluid to be ejected. In some examples, the frame (218) holds one fluid ejection device. However, as depicted in FIG. 3, in some examples, the frame (218) holds multiple fluid ejection devices.

The top of the frame (218) includes a reservoir (220), which may be exposed to atmosphere such that fluid can be dispensed therein without having to remove a cap. That is, a user may insert fluid directly into the reservoir (220) using a single-channel or multi-channel pipette.

In some examples the frame (218) also houses circuitry to activate each of the fluid actuators (FIG. 1, 110). That is, each of the fluid actuators (FIG. 1, 110) may be individually addressable and may activate based on control signals from a fluid ejection controller. Specifically, the frame (218) includes electrical connections (222) on a top surface of the frame (218). These electrical connections (222) interface with corresponding connections on a fluid ejection controller to pass control signals. These electrical connections (222) are connected to traces that are connected to the fluid ejection die (FIG. 1, 100), which traces are indicated in FIG. 2B. For simplicity, in FIG. 2A, one electrical connection (222) is indicated with a reference number.

During operation, a fluid ejection controller passes control signals to the fluid ejection system (216). Any number of control signals may be passed. For example, ejection signals may activate fluid actuators (FIG. 1, 110) on the fluid ejection devices to eject fluid therefrom. Other types of signals include sensing signals to activate a sensor to collect data regarding the fluid ejection device or a fluid passing through the fluid ejection device. As yet another example, a signal may activate a component of the fluid ejection device to electrically discharge fluid being ejected into the wells of the titration plate. While specific reference is made to particular control signals generated and/or passed, any number and type of control signals may be passed to the fluid ejection system (100) by the fluid ejection controller.

FIG. 2B is a bottom view of a fluid ejection system (216) including a fluid ejection device with a fluid ejection die (100) with a fluid cleaning structure (FIG. 1, 114), according to an example of the principles described herein.

The bottom of the frame (218) depicts the fluid ejection die (100) with its corresponding array of nozzles (FIG. 1, 104) that eject fluid. As described above, traces (224) route signals received at the electrical connections (FIG. 2A, 222) on the top surface of the frame (218) to the fluid ejection die (100) on the bottom of the frame (218). For simplicity, in FIG. 2B, one electrical trace (224) is indicated with a reference number.

FIG. 3 is a top view of a fluid ejection system (216) including multiple fluid ejection devices (326) with a fluid ejection die (FIG. 1, 100) with a fluid cleaning structure (FIG. 1, 114), according to an example of the principles described herein. As depicted in FIGS. 2A and 2B, in some examples, the frame (218) houses one fluid ejection device (326). However, in some examples, as depicted in FIG. 3, the frame (218) houses multiple fluid ejection devices (326), In this example, each fluid ejection device (326), is a separate structure. For simplicity, in FIG. 3 one fluid ejection device (326) is indicated with a reference number. In this example, the multiple reservoirs (220) can be filled simultaneously via a multi-channel pipette.

In some examples, the number of fluid ejection devices (326) align with the number of wells in a titration plate. For example, as depicted in FIG. 3, the fluid ejection system (216) includes eight fluid ejection devices (326) to align with eight wells in a titration plate. While FIG. 3 specifically depicts eight fluid ejection devices (326), other numbers of fluid ejection devices (326) may be held in the frame (218). By aligning fluid ejection devices (326) with wells in a titration plate and pipette tips of multi-channel pipettes, multi-plex reservoir (220) filling and fluid ejection is enabled.

As described above, the fluidic ejection devices include fluid ejection dies (FIG. 1, 100) with fluid cleaning structures (FIG. 1, 114) which allow live cells in the fluid to pass to the nozzle (FIG. 1, 104) while capturing other components. For example, over the course of time, live cells in a target fluid burst or otherwise die. Additionally, debris may contaminate the target fluid. Such dead cells, burst cells, and/or debris can affect the accuracy of fluid analysis results and can impact performance of the fluid ejection die (FIG. 1, 100). Accordingly, the fluid cleaning structure (FIG. 1, 114) separates the live cells from the dead cells, burst cells, and other debris to enhance analysis performance and improve fluid ejection die (FIG. 1, 100) life and performance.

Such a fluid cleaning structure (FIG. 1, 114), by cleaning a fluid of dead cells, burst cells, or other debris, enhances the ratio of live, viable cells within a target fluid. Accordingly, cell counting operations that occur downstream of the fluid cleaning structure (FIG. 1, 114) do not mistakenly count dead cells and/or burst cells as live cells, thus enhancing the accuracy of such operations. Moreover, the fluid cleaning structure (FIG. 1, 114) prevents dead cells, burst cells, and/or other debris from clogging fluid ejection die (FIG. 1, 100) components such as ejection chambers (FIG. 1, 106), openings (FIG. 1, 108) or other sensors that may be found within the fluid ejection die (FIG. 1, 100). These effects, in addition to others, result in more accurate ejection, more accurate analysis of a corresponding fluid, and an increased life of components of the fluid ejection die (FIG. 1, 100) and therefore the fluid ejection die (FIG. 1, 100) as a whole

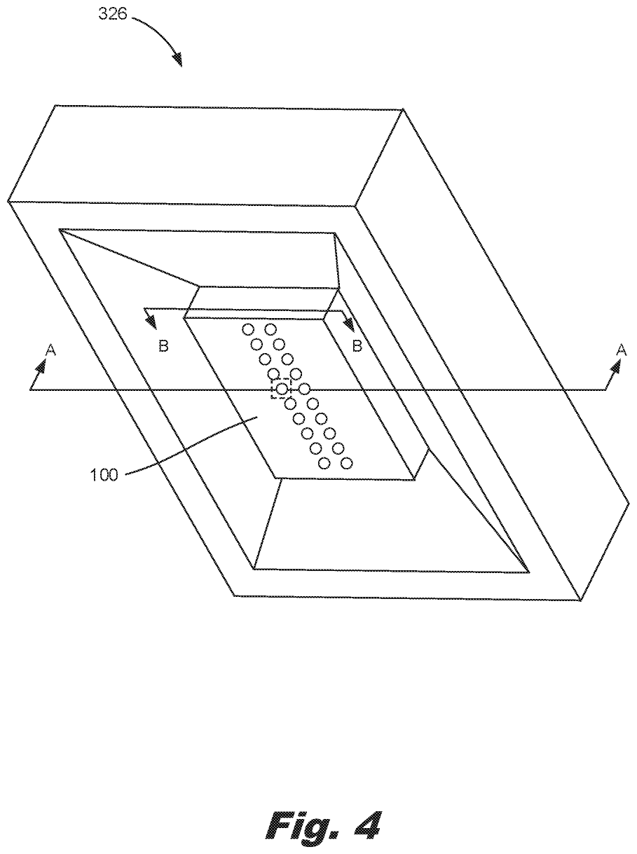

FIG. 4 is a view of a fluid ejection device (326) with a fluid ejection die (100) with a fluid cleaning structure (FIG. 1, 114), according to an example of the principles described herein. Specifically, FIG. 4 depicts the fluid ejection device (326) removed from the frame (FIG. 2, 218). FIG. 4 clearly depicts the openings (FIG. 1, 108) of the nozzle array. Note however, that the size of the openings (FIG. 1, 108) is not to scale relative to the size of the fluid ejection die (100), with the openings (FIG. 1, 108) being enlarged for reference,

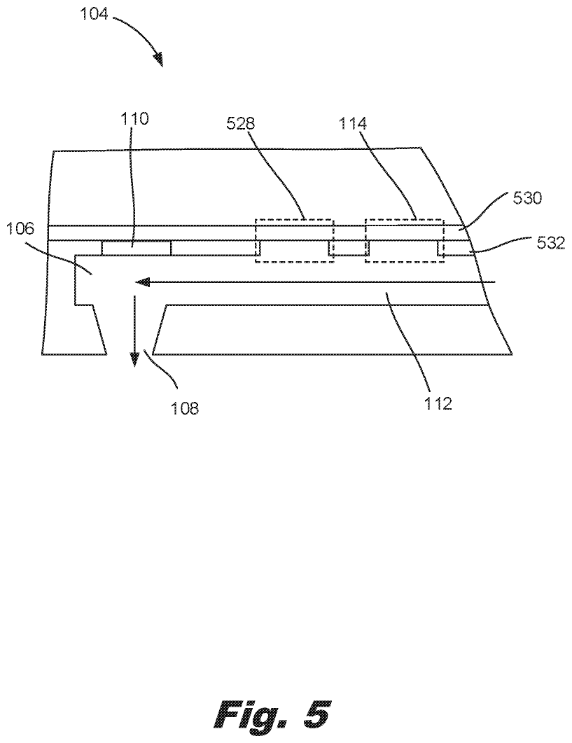

FIG. 5 is a side cross-sectional view of a nozzle (104) of a fluid ejection die (FIG. 1, 100) with a fluid cleaning structure (114), according to an example of the principles described herein. More specifically, FIG. 5 is a portion of a cross section taken along the line A-A in FIG. 4, the portion being identified by the dashed box in FIG. 4.

As described above, each nozzle (104) includes an opening (108) through which fluid is ejected, an ejection chamber (106) wherein fluid to be ejected is held, a fluid actuator (110) that operates to eject the fluid, and a fluid channel (112) to deliver the fluid from a fluid feed slot (FIG. 1, 102) to the ejection chamber (106) for ejection. In FIG. 5, the fluid path is indicated by an arrow.

Also as described above, the fluid ejection die (FIG. 1, 100) includes a fluid cleaning structure (114) which may be a gold surface that is found within the fluid channel (112) of a nozzle (104), Each nozzle (104) may have such a fluid cleaning structure (114). As will be described below, the fluid cleaning structure (114) may be found in different locations within the fluid ejection die (FIG. 1, 100).

As described above, the fluid cleaning structure (114) may be a gold surface that is exposed by etching a substrate layer (532). That is, a substrate layer (532), for example made of silicon oxide, may be superimposed over a gold layer (530). This substrate layer (532) may be etched to expose a portion of the underlying gold layer (530), which underlying portion defines the fluid cleaning structure (114). As the target fluid passes, dead cells, burst cells, and debris are attracted to the gold fluid cleaning structure (114) thus preventing them from entering further into the system, i.e., near the sensor (528), fluid actuator (110), and opening (108).

As depicted in FIG. 5, in some examples the fluid cleaning structure (114) is upstream of the sensors (528). Accordingly, any operation performed by the sensors (528) is not impeded by the presence of dead cells and/or burst cells. For example, the sensor (528) may count cells as they pass and output that information for subsequent analysis. The sensor (528) may not be able to detect a difference between dead cells and live cells and thus output a cell count that is not reflective of live cells in the target fluid, but that indicates a number of live cells and dead cells. Accordingly, the accuracy of subsequent analysis could be compromised without the removal of dead cells and/or burst cells.

The removal of dead cells and burst cells before arriving at the sensor (528) also prolongs the life of the sensor (528), and thereby the entire fluid ejection die (FIG. 1, 100). That is, dead cells and/or burst cells can accumulate on the sensor (528) leading to less accurate readings, and in some cases can prevent any readings at all. Accordingly, the fluid cleaning structure (114) by capturing the dead and/or burst cells beforehand, prevents these cells from accumulating on, and blocking the sensor (528).

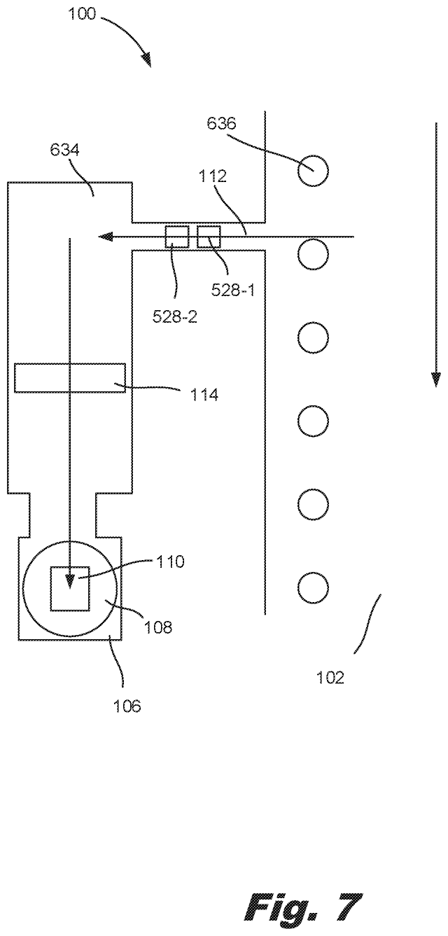

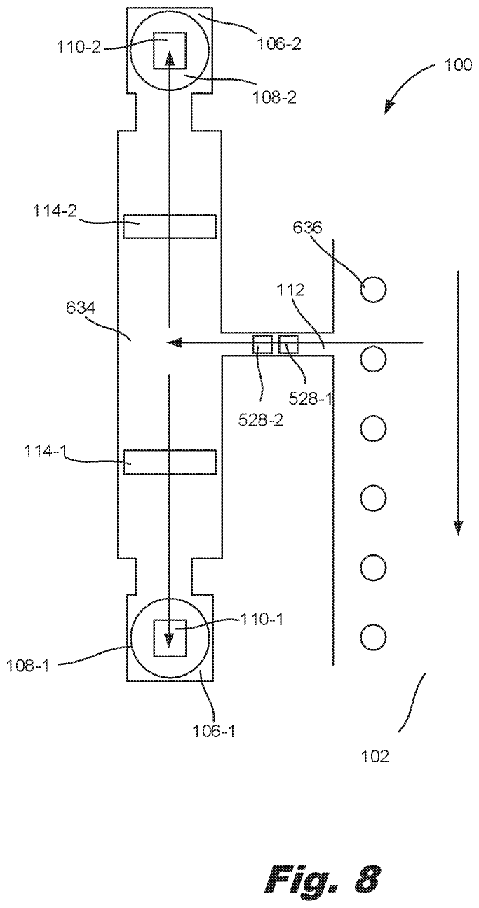

As described, in some examples, each nozzle (104) includes a fluid sensor (528) to detect a condition of the fluid passing by. For example, a fluid sensor (528) could be used to detect materials within the fluid such as the presence, and size of, a cell within the target fluid. Such fluid sensors (528) may also be able to detect properties of the fluid such as a temperature and conductivity. As depicted in FIG. 5, such fluid sensors (528) may be downstream of the fluid cleaning structure (114). In other examples, for example as depicted in FIGS. 7 and 8, such fluid sensors (528) may be upstream of the fluid cleaning structures (114).

As depicted in FIG. 5, the fluid cleaning structure (114) and the fluid actuator (110), as well as the fluid sensor (528) may be disposed on a first surface of the fluid channel (112). In this example, the opening (118) of the nozzle (104) may be disposed on a second surface, which second surface is opposite the first surface.

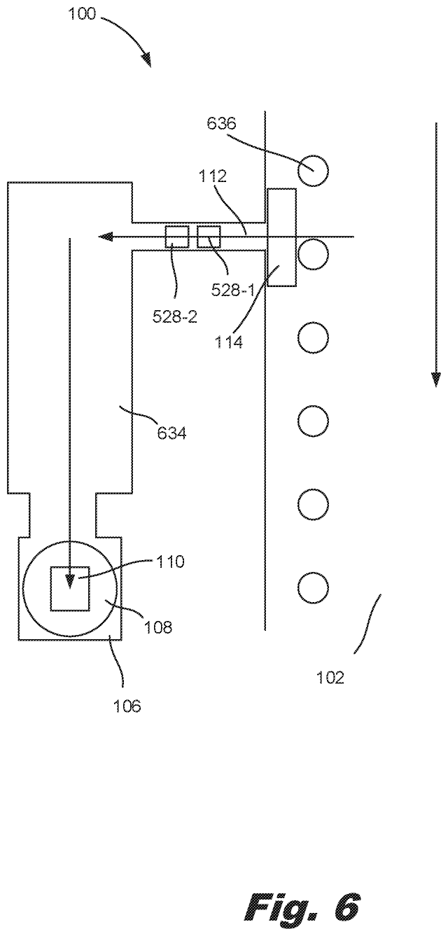

FIG. 6 is a top cross-sectional view of a portion of a fluid ejection die (100) with a fluid cleaning structure (114), according to an example of the principles described herein. More specifically, FIG. 6 is a portion of a cross section taken along the line B-B in FIG. 4.

As described above, fluid passes through a fluid feed slot (102), and is introduced into a fluid channel (112) of a nozzle (FIG. 1, 104). The fluid then makes its way to the ejection chamber (106), where it is ejected through an opening (108) by the fluid actuator (110). In this example, the fluid is ejected vertically, out of the page.

In some examples, the nozzle (FIG. 1, 104) further includes an antechamber (634) between the fluid channel (112) and the ejection chamber (106). During operation, fluid flowing into and out of the fluid channel (112) has a certain velocity. The antechamber (634) provides a place for the fluid to slow down, thus preventing the negative effects that can occur if turbulent fluid exists within the ejection chamber (106).

FIG. 6 also depicts two fluid sensors (528-1, 528-2) disposed within the fluid channel (112). While FIG. 6 depicts the fluid sensors (528) as being disposed within the fluid channel (112), the fluid sensors (528) can be disposed in any other portion of the fluid ejection die (FIG. 1, 100).

FIG. 6 also depicts the fluid cleaning structure (114). In some examples the fluid cleaning structure (114) may be disposed on a shelf at an entrance to the fluid channel (112).

In some examples, the fluid ejection die (100) includes a number of particle trapping structures (636). These particle trapping structures (636) may be protrusions, such as columns, that prevent large particles from entering the nozzle (FIG. 1, 104) of the fluid ejection die (100). For simplicity, a single particle trapping structure (636) is identified with a reference number.

FIG. 7 is a top cross-sectional view of a portion of a fluid ejection die (100) with a fluid cleaning structure (114), according to an example of the principles described herein. More specifically, FIG. 7 is a portion of a cross section taken along the line B-B in FIG. 4. FIG. 7 depicts the fluid feed slot (102), particle trapping structures (636), fluid channel (112), fluid sensors (528), opening (108), fluid actuator (110), and ejection chamber (106) as described above. FIG. 7 also depicts the antechamber (634) that is included in some examples. In some examples, the fluid cleaning structure (114) is disposed within the antechamber (634). Accordingly, the fluid sensors (528) are upstream of the fluid cleaning structure (114).

FIG. 8 is a top cross-sectional view of a portion of a fluid ejection die (100) with a fluid cleaning structure (114-1, 114-2), according to an example of the principles described herein. More specifically, FIG. 8 is a portion of a cross section taken along the line B-B in FIG. 4. FIG. 8 depicts the fluid feed slot (102), particle trapping structures (636), fluid channel (112) and fluid sensors (528) described above.

In some examples as depicted in FIG. 8, multiple nozzles (FIG. 1, 104) share an antechamber (634). That is, fluid travels through a shared fluid channel (112), passes into the antechamber (634) and is passed to different nozzles (FIG. 1, 104), each with their own opening (108-1, 108-2), ejection chamber (106-1, 106-2), and fluid actuator (110-1, 110-2).

FIG. 8 also depicts an example where more than one fluid cleaning structure (114-1, 114-2) is used. In this example, each fluid cleaning structure (114) is disposed downstream of the fluid sensors (528) and upstream of its corresponding nozzle (FIG. 1, 104).

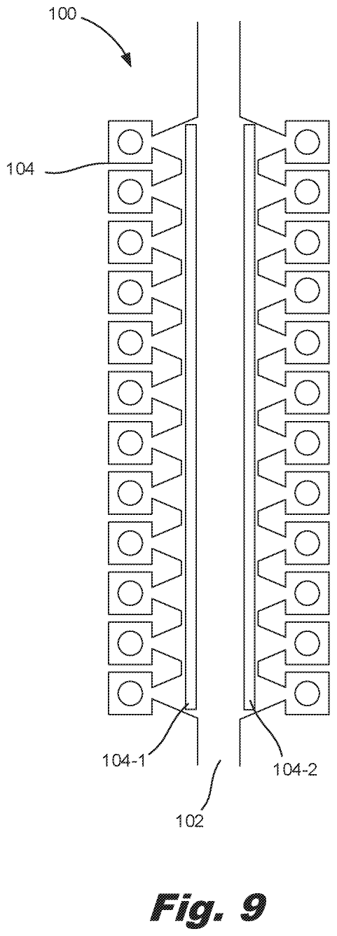

FIG. 9 is a top cross-sectional view of a portion of a fluid ejection die (100) with a fluid cleaning structure (114-1, 114-2), according to an example of the principles described herein. In FIG. 9, multiple nozzles (104) are depicted, however just one is indicated with a reference number. In this example, a fluid cleaning structure (114-1, 114-2) is disposed on a shelf at the edge of the fluid feed slot (102) at the entrance to multiple fluid channels (FIG. 1, 112) of multiple nozzles (104). Doing so may simplify manufacturing of the fluid ejection die (100) as a single long fluid cleaning structure (114) is manufactured as opposed to many small instances.

In summary, using such a fluid ejection die 1) enables ejection of cells onto a surface such as a titration plate; 2) allows dispensing of small quantities of a target fluid that includes the cells; 3) cleans dead cells, burst cells, and other debris from a target fluid resulting in a better target fluid with a higher ratio of live cells; 4) reduces cell counting errors by reducing the cell debris which improves the ability for a closed-loop system to accurately dispense the right amount of cells; 5) lengthens sensor, and fluid ejection device, life by preventing the contamination; blocking or damage to sensors via the cell debris; 6) prevents channel, chamber, and nozzle clogging; 7) enables improved understanding of heterogeneous biological samples; 8) facilitates efficient cell isolation; and 9) reduces the pre-dispensing operations as less cleaning and centrifuging is performed. However; it is contemplated that the devices disclosed herein may address other matters and deficiencies in a number of technical areas.

What is claimed is:

1. A fluid ejection die, comprising:
a fluid feed slot to deliver fluid from a reservoir to an array of nozzles;
the array of nozzles; each nozzle comprising:
an ejection chamber;
an opening;
a fluid actuator disposed within the ejection chamber; and
a fluid channel between the fluid feed slot and the ejection chamber; and
a fluid cleaning structure to allow live cells in the fluid to pass to the nozzle.

2. The fluid ejection die of claim 1, wherein the fluid is a biological fluid that comprises dead cells to be captured by the fluid cleaning structures.

3. The fluid ejection die of claim 1, wherein the fluid is a biological fluid that comprises burst cells to be captured by the fluid cleaning structures.

4. The fluid ejection die of claim 1, wherein the fluid cleaning structure is a gold surface along a fluid path through the fluid ejection die.

5. The fluid ejection die of claim 4; wherein the gold surface is a portion of a layer of gold material that underlies a substrate layer in which the ejection chamber and fluid channel are formed.

6. The fluid ejection die of claim 1, wherein the fluid cleaning structure is disposed within the fluid channel of the nozzle.

7. A fluid ejection device comprising:
a reservoir to receive a quantity of fluid; and
a fluid ejection die comprising:
a fluid feed slot to deliver fluid from the reservoir to an array of nozzles;
the array of nozzles, each nozzle comprising:
an ejection chamber;
an opening;
a fluid actuator disposed within the ejection chamber; and
a fluid channel between the fluid feed slot and the nozzle; and
a fluid cleaning structure to capture dead and burst cells.

8. The fluid ejection device of claim 7, wherein:
each nozzle further comprises a fluid sensor; and
the fluid sensor is upstream, along a fluid path, of the fluid cleaning structure.

9. The fluid ejection device of claim 7, wherein:
each nozzle further comprises a fluid sensor; and
the fluid sensor is downstream, along a fluid path, of the fluid cleaning structure.

10. The fluid ejection device of claim 7, wherein:
the fluid cleaning structure and fluid actuator are disposed on a first surface along a fluid path; and
the opening is disposed on a second surface along the fluid path, which second surface is opposite the first surface.

11. The fluid ejection device of claim 7, wherein the fluid cleaning structure of the fluid ejection die is disposed on a shelf at an edge of the fluid feed slot of the fluid ejection die.

12. The fluid ejection device of claim 7, wherein within the fluid ejection die:
each nozzle further comprises an antechamber between the ejection chamber and the fluid channel; and
the fluid cleaning structure is disposed within the antechamber.

13. A fluid ejection system comprising:
a number of fluid ejection devices; each fluid ejection device comprising:
a reservoir to receive a quantity of fluid; and
a fluid ejection die comprising:
a fluid feed slot to deliver fluid from the reservoir to an array of nozzles;
the array of nozzles, each nozzle comprising:
an ejection chamber;
an opening;
a fluid actuator disposed within the ejection chamber; and
a fluid channel between the fluid feed slot and the nozzle; and
a fluid cleaning structure to allow live cells in the fluid to pass to the nozzle while capturing dead and burst cells; and
a frame to retain the number of fluid ejection devices.

14. The fluid ejection system of claim 13, wherein a single cleaning structure is disposed upstream, along a fluid path, of fluid channels of multiple nozzles.

15. The fluid ejection system of claim 13, further comprising a number of particle trapping structures disposed on a shelf at an edge of the fluid feed slot at the entrances of each fluid channel.
